(19) United States
(12) Patent Application Publication
(10) Pub. No.: US 2024/0202015 A1
(43) Pub. Date: Jun. 20, 2024

(54) Accessing Multiple Physical Partitions of a Hardware Device

(71) Applicants: Advanced Micro Devices, Inc, Santa Clara, CA (US); ATI Technologies ULC, Markham (CA)

(72) Inventors: Lu Lu, Chaoyang District (CN); Anthony Asaro, Toronto (CA); Gia Tung Phan, Toronto (CA); Gongxian Cheng, Toronto (CA); Philip Ng, Toronto (CA); Yinan Jiang, Richmond Hill (CA); Felix Kuehling, North York (CA)

(21) Appl. No.: 18/066,155

(22) Filed: Dec. 14, 2022

(51) Int. Cl. G06F 9/455; G06F 9/54

(52) U.S. Cl. CPC G06F 9/45545; G06F 9/45558; G06F 9/545; G06F 2009/4557; G06F 2009/45579

(57) ABSTRACT

In a computing device, a hardware device (e.g., a parallel accelerated processor or graphics processing unit) is coupled to a bus, such as a peripheral component interconnect express (PCIe) bus. The hardware device supports physical partitioning that allows physical resources of the hardware device to be separated into different partitions. Examples of such physical resources include engine resources (e.g., compute resources, direct memory access resources), memory resources (e.g., random access memory), and so forth. Each physical partition is mapped to a physical function that is exposed to a host on the computing device in a manner that is compliant with the bus protocol, allowing software to access the physical partition in a conventional manner based on the bus protocol.

### BACKGROUND

Modern computer systems provide a wide range of functionality. One way in which this functionality is provided is through the use of various devices coupled to one or more processors in the computer system, such as via a peripheral component interconnect express (PCIe or PCI-e) bus.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a non-limiting example system that is operable to employ the accessing multiple physical partitions of a hardware device described herein.

FIG. 2 is an illustration of another non-limiting example system that is operable to employ the accessing multiple physical partitions of a hardware device described herein.

FIG. 3 is an illustration of the correspondence between software and physical partitions in accordance with one or more implementations.

FIG. 4 is another illustration of the correspondence between software and physical partitions in accordance with one or more implementations.

FIG. 5 is a flow diagram depicting a procedure in an example implementation of accessing multiple physical partitions of a hardware device.

### DETAILED DESCRIPTION

### Overview

In a computing device, a hardware device (e.g., a parallel accelerated processor or graphics processing unit (GPU)) is coupled to a bus, such as a PCIe bus. The hardware device supports physical partitioning that allows physical resources of the hardware device to be separated into different partitions. Examples of such physical resources include engine resources (e.g., compute resources, direct memory access (DMA) resources), memory resources (e.g., random access memory (RAM)), and so forth. Each physical partition is mapped to a physical function that is exposed to a host on the computing device in a manner that is compliant with the bus (e.g., PCIe) protocol, allowing software to access the physical partition in a conventional manner based on the bus protocol.

The techniques discussed herein operate in a bare metal environment, allowing software on a computing device to access the different physical partitions of the hardware device (via the mapped to physical functions) without having a hypervisor running on the computing device. Furthermore, the techniques discussed herein allow the functionality of a hardware device to be shared concurrently by multiple pieces of software. By using different physical partitions, time-sharing need not be employed for different pieces of software to use the hardware device. Rather, the different physical partitions are runnable at the same time, each performing operations for different software.

In some aspects, the techniques described herein relate to a method including: exposing a physical function of a hardware device on a bus, the physical function corresponding to a physical partition of multiple physical partitions of the hardware device; receiving, via the physical function, a request to perform one or more operations; and performing the one or more operations on the physical partition.

In some aspects, the techniques described herein relate to a method, wherein the bus includes a peripheral component interconnect express bus.

In some aspects, the techniques described herein relate to a method, further including: exposing an additional physical function of the hardware device on the bus, the additional physical function corresponding to a device management module of the hardware device that manages the multiple physical partitions of the hardware device.

In some aspects, the techniques described herein relate to a method, further including: receiving configuration information corresponding to software, the configuration information indicating resources requested for execution of the software; and configuring, based on the received configuration information, a physical partition including the indicated resources.

In some aspects, the techniques described herein relate to a method, the software comprising a software container, an application, or a software stack.

In some aspects, the techniques described herein relate to a method, further including: exposing an additional physical function of the hardware device on the bus, the additional physical function corresponding to an additional physical partition of the multiple physical partitions; receiving, via the additional physical function, a request to perform at least one operation; and performing the at least one operation on the additional physical partition.

In some aspects, the techniques described herein relate to a method, wherein the request is received from software via a kernel mode driver of a host rather than via a hypervisor.

In some aspects, the techniques described herein relate to a device including: a physical function exposable on a bus coupled to the device to receive a request to perform one or more operations; and a physical partition, corresponding to the physical function, to perform the one or more operations, wherein the physical partition is one of multiple physical partitions of the device.

In some aspects, the techniques described herein relate to a device, wherein the bus includes a peripheral component interconnect express bus.

In some aspects, the techniques described herein relate to a device, further including: an additional physical function exposable on the bus; and a device management module, corresponding to the additional physical function, that manages the multiple physical partitions of the device.

In some aspects, the techniques described herein relate to a device, wherein the device management module is to: receive, via the bus and the additional physical function, configuration information corresponding to software, the configuration information indicating resources requested for execution of the software; and configure, based on the received configuration information, the physical partition including the indicated resources.

In some aspects, the techniques described herein relate to a device, wherein the configuration information is received from a management application that provides an interface to manage resources in the device.

In some aspects, the techniques described herein relate to a device, further including: an additional physical function exposable on the bus to receive a request to perform at least one operation; and an additional physical partition, corresponding to the additional physical function, to perform the at least one operation, wherein the additional physical partition is one of the multiple physical partitions.

In some aspects, the techniques described herein relate to a device, wherein the request is received from software via a kernel mode driver of a host rather than via a hypervisor.

In some aspects, the techniques described herein relate to a computing device including: a bus; and a hardware device coupled to the bus, the hardware device including a physical function exposed on the bus to receive, via the bus, a request to perform one or more operations, and the hardware device further including a physical partition, corresponding to the physical function, to perform the one or more operations, wherein the physical partition is one of multiple physical partitions of the hardware device.

In some aspects, the techniques described herein relate to a computing device, wherein the bus includes a peripheral component interconnect express bus.

In some aspects, the techniques described herein relate to a computing device, further including: an additional physical function exposed on the bus; and a device management module, corresponding to the additional physical function, that manages the multiple physical partitions of the hardware device.

In some aspects, the techniques described herein relate to a computing device, wherein the device management module is to: receive, via the bus and the additional physical function, configuration information corresponding to software, the configuration information indicating resources requested for execution of the software; and configure, based on the received configuration information, the physical partition including the indicated resources.

In some aspects, the techniques described herein relate to a computing device, further including: an additional physical function exposed on the bus to receive a request to perform at least one operation; and an additional physical partition, corresponding to the additional physical function, to perform the at least one operation, wherein the additional physical partition is one of the multiple physical partitions.

In some aspects, the techniques described herein relate to a computing device, wherein the request is received from software via a kernel mode driver of a host rather than via a hypervisor.

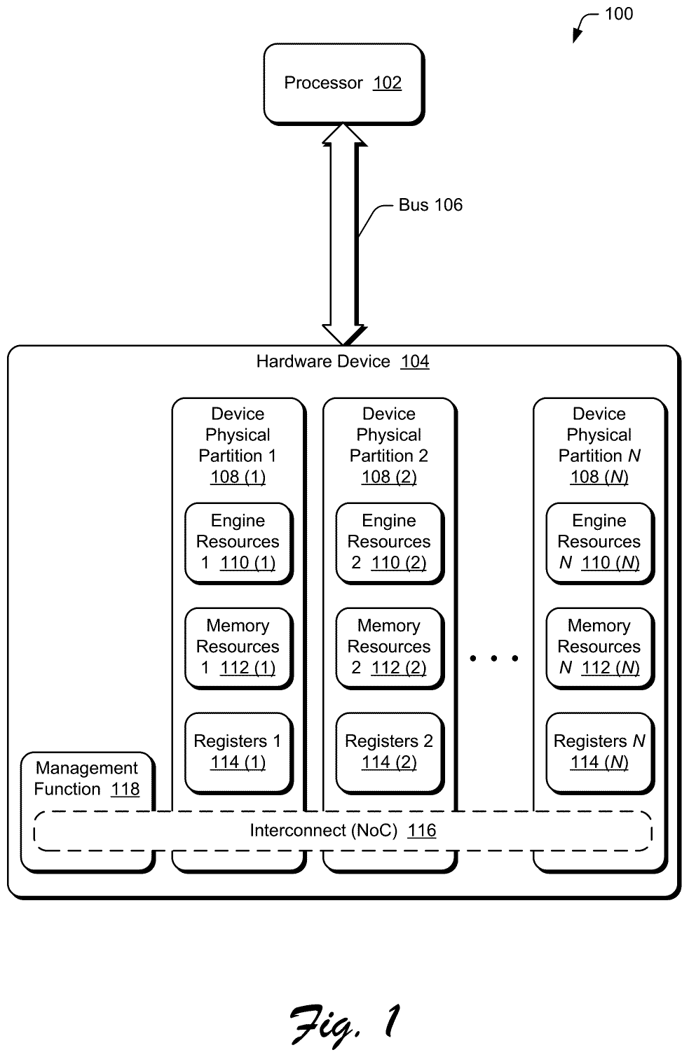

FIG. 1 is an illustration of a non-limiting example system 100 that is operable to employ the accessing multiple physical partitions of a hardware device described herein. The system 100 includes a processor 102, a hardware device 104, and a bus 106. The processor 102 includes one or more cores. Although a single processor 102 is illustrated, additionally or alternatively one or more processors of the same type as processor 102 or a different type than processor 102 are included in the system 100.

The bus 106 is any of a variety of high-speed busses. In one or more implementations, the bus 106 is a PCIe bus.

The hardware device 104 is any of a variety of physical devices that are couplable to the bus 106, such as a GPU, a parallel accelerated processor, an input/output (I/O) device, and so forth. The hardware device 104 includes multiple (N) physical partitions 108 (1), . . . , 108 (N). Each physical partition 108 includes one or more engine resources, such as compute resources (e.g., processor cores or processor clusters), DMA engines, and so forth. These engine resources are illustrated as engine resources 110 (1), . . . , 110 (N) in the hardware device 104. Each physical partition 108 also includes one or more memory resources, such as RAM, memory channels (e.g., channels to system memory external to the hardware device 104), and so forth. These memory resources are illustrated as memory resources 112 (1), . . . , 112 (N) in the hardware device 104.

Each physical partition also includes one or more registers, which store data or information to be used by one or more of the engine resources in the physical partition. These registers are illustrated as registers 114 (1), . . . , 114 (N)

The hardware device 104 also includes an interconnect 116 (e.g., a network-on-a-chip (NoC). The interconnect 116 allows a management function 118 to communicate information to and from the physical partitions or management control modules as discussed in more detail below.

The hardware device 104 exposes multiple physical functions on the bus 106. Exposing a physical function on the bus 106 refers to making the physical function accessible to applications running on the processor 102, such as by exposing a name, address, or other identifier of the physical function which is then used by the application to send data or instructions to, or receive data or instructions from, the physical partition corresponding to the physical function. A physical function supports a full configuration space (e.g., configuration space registers) and thus operates without needing a hypervisor running on the device implementing the system 100. Physical functions differ from virtual functions in that the physical functions support a full configuration space in the hardware device 104 whereas virtual functions rely on a hypervisor running on the device implementing system 100 to construct the full configuration space (e.g., configuration space registers). Each physical partition 108 corresponds to a physical function, as discussed in more detail below.

In one or more implementations, the physical partitions 108 are configurable and changeable over time. For example, at different times a particular physical partition 108 includes one set of engine resources 110 and memory resources 112, and at another time that particular physical partition includes a different set of engine resources 110 and memory resources 112. This allows the physical partitions to change and adapt to the needs or requests of software running on the processor 102.

The system 100 is implementable in any of a variety of different types of computing devices. For example, the system 100 is implementable in a server, a desktop computer, a smartphone or other wireless phone, a tablet or phablet computer, a notebook computer (e.g., netbook or ultrabook), a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television), an Internet of Things (IOT) device, an automotive computer, and so forth.

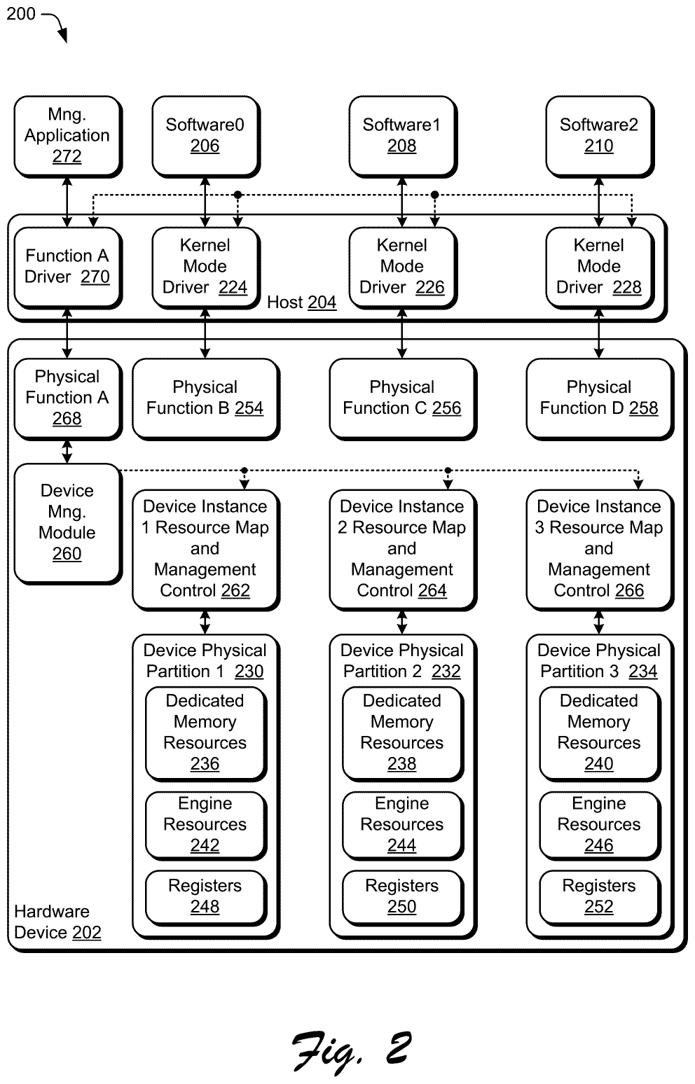

FIG. 2 is an illustration of another non-limiting example system 200 that is operable to employ the accessing multiple physical partitions of a hardware device described herein. The system 200 includes a hardware device 202, a host 204, software 206, software 208, and software 210. The software 206, software 208, and software 210 are also referred to as different pieces of software, each of which includes one or more programs. The hardware device 202 is, for example, a hardware device 104 of FIG. 1. The system 200 is implementable in any of a variety of different types of computing devices, such as any of the types of computing devices discussed above with reference to the system 100 of FIG. 1.

Each of the software 206, 208, and 210 takes any of a variety of different forms. Examples of software 206, 208, and 210 include an application, a container, an operating system, a driver, a software stack (e.g., a set of software operating together to support execution of an application), combinations thereof, and so forth. A container, also referred to as a software container, includes one or more applications along with any libraries, frameworks, dependencies, user mode drivers, other binaries, configuration files, and so forth used to run the one or more applications. The container shares the kernel of the host operating system of a computing device with other containers running in the computing device. Accordingly, the containers execute independently of, and without need for, a hypervisor.

In the system 200, each software 206, 208, and 210 is optionally a software container that includes one or more applications and a user mode driver. The software 206, 208, and 210 share a kernel of the host 204, which is a host operating system. The host 204 includes kernel mode drivers 224, 226, and 228, corresponding to software 206, 208, and 210, respectively. The software 206, 208, and 210 communicate with the kernel mode drivers 224, 226, and 228, allowing the software 206, 208, and 210 to send requests to and receive responses from a physical partition of the hardware device 202 corresponding to the software 206, 208, and 210, as discussed in more detail below.

The hardware device 202 includes physical partition 230, physical partition 232, and physical partition 234. Although three physical partitions are illustrated in the hardware device 202, it is to be appreciated that the hardware device 202 optionally includes a smaller or larger number of physical partitions. The physical partitions 230, 232, and 234 include dedicated memory resources 236, 238, and 240, respectively, as well as engine resources 242, 244, and 246, respectively, and registers 248, 250, and 252, respectively. The physical partitions 230, 232, and 234, the memory resources 236, 238, and 240, the engine resources 242, 244, and 246, and the registers 248, 250, and 252 are analogous to the physical partitions, memory resources, engine resources, and registers discussed above with reference to FIG. 1.

Each physical partition 230, 232, and 234 corresponds to a physical function 254, 256, and 258, respectively. Each physical function 254, 256, and 258 is exposed on the bus (e.g., bus 106 of FIG. 1), allowing the software 206, 208, and 210 to access one of the physical partitions. In the system 200, software 206 accesses physical partition 230 via the kernel mode driver 224 and the physical function 254. Similarly, software 208 accesses physical partition 232 via the kernel mode driver 226 and the physical function 256. Similarly, software 210 accesses physical partition 234 via the kernel mode driver 228 and the physical function 258.

Accordingly, rather than having a single physical function that corresponds to the entirety of the hardware device 202 (e.g., a parallel accelerated processor or GPU), the functionality of the hardware device 202 is separated into the multiple physical partitions. For example, the hardware device 202 has multiple (e.g., three different) parallel accelerated processors or GPUs exposed and available to software 206, 208, and 210 for use.

The hardware device 202 also includes a device management (Mng.) module 260 as well as resource map and management control modules corresponding to the physical partitions. These resource map and management control modules are illustrated as resource map and management control 262 corresponding to the physical partition 230, resource map and management control 264 corresponding to the physical partition 232, and resource map and management control 266 corresponding to the physical partition 234. The resource map and management control module corresponding to a physical partition identifies the resources (e.g., dedicated memory resources, engine resource, and registers) in the corresponding physical partition. The resources in a particular physical partition 230, 232, or 234 are configurable by the device management module 260.

The hardware device 202 also includes a physical function 268 that is exposed on the bus (e.g., bus 106 of FIG. 1) analogous to physical functions 254, 256, and 258. The physical function 268 is, for example, the management function 118 of FIG. 1. At initialization time for the system 200, the physical function 268 is exposed on the bus, followed by the physical functions 254, 256, and 258. This allows the device management module 260 to receive configuration information for the different physical functions and corresponding physical partitions via the physical function 268, configure the resources for the physical partitions and corresponding physical functions, after which the physical functions 254, 256, and 258 are exposed on the bus.

The physical function 268 corresponds to a function driver 270 in the host 204, which together allow configuration information to be communicated to the device management module 260. The configuration information indicates what resources are to be used by software 206, 208, or 210. These resources are specified in any of various manners, such as explicitly identifying resources (e.g., identifying particular engine resources, identifying particular memory channels or amounts of memory, and so forth). Additionally or alternatively, these resources are specified implicitly, such as a particular performance requested from which the device management module 260 is able to determine the resources to assign to the software 206, 208, or 210.

In one or more implementations, the device management module 260 receives the configuration information from a management (Mng.) application 272. A kernel mode driver (e.g., function driver 270 or another kernel mode driver) discovers and reports the resources and capabilities of the hardware device 202 during an initialization time. The management application 272 receives this information describing the resources and capabilities of the hardware device 202, determines which physical partitions are to be configured with which resources, and sends an indication of which physical partitions are to be configured with which resources to the device management module 260 via the function driver 270 and physical function 268. The device management module 260 communicates with the resource map and management control 262, 264, and 266, and corresponding physical functions 254, 256, and 258, to configure the resources for the physical partitions 230, 232, and 234. The management application 272 determines which physical partitions are to be configured with which resources in any of various manners, such as based on input from a user or administrator of the device implementing the system 200, requested resources for software (e.g., a software container) that will be launched (e.g., as indicated in metadata or setup data associated with the software), and so forth. Accordingly, the management application 272 provides an interface to manage the resources in the hardware device 202.

Additionally or alternatively, the device management module 260 receives the configuration information from other sources, such as directly from the host 204 (e.g., the configuration information being included as metadata or setup data associated with software 206, 208, or 210 when the software begins executing in the system 200).

The resource map and management control 262 maintains a record of the resources that make up the physical partition 230. Based on the received configuration information for the software 206, the device management module 260 determines which resources to assign to the physical partition 230 and provides an indication of those resources to the resource map and management control 262. The resource map and management control 262 generates the physical partition 230 that includes the resources indicated by the device management module 260.

Similarly, the resource map and management control 264 maintains a record of the resources that make up the physical partition 232. Based on the received configuration information for the software 208, the device management module 260 determines which resources to assign to the physical partition 232 and provides an indication of those resources to the resource map and management control 264. The resource map and management control 264 generates the physical partition 232 that includes the resources indicated by the device management module 260.

Similarly, the resource map and management control 266 maintains a record of the resources that make up the physical partition 234. Based on the received configuration information for the software 210, the device management module 260 determines which resources to assign to the physical partition 234 and provides an indication of those resources to the resource map and management control 266. The resource map and management control 266 generates the physical partition 234 that includes the resources indicated by the device management module 260.

The resource map and management control 262, 264, and 266 further restrict access to the resources in their corresponding physical partitions to the corresponding physical function. This provides security to the operation information used in a physical partition due to requests received by a physical function that does not correspond to the physical partition not being able to access the physical partition. For example, the resource map and management control 264 restricts access to the physical partition 232 to the physical function 256, ignoring or otherwise preventing any requested operations received by the physical function 254 or the physical function 258 from being performed by the physical partition 232.

In one example implementation, the hardware device 202 is coupled to a PCIe bus that supports exposing up to eight physical functions on the PCIe bus. In this example, the physical function 268 (e.g., exposed on the PCIe bus by the hardware device 202 as physical function 0) is mapped to the device management module 260 and the physical function 254, physical function 256, and physical function 258 (e.g., exposed on the PCIe bus by the hardware device 202 as physical function 4, physical function 5, and physical function 6, respectively) are each mapped to one of three different partitions on the hardware device 202.

The physical partitions are dynamic and changeable over time. For example, in one or more implementations if software stops running or is no longer needed, the resources in the physical partition that was running the software are released and are assignable to one or more new physical partitions. Additionally or alternatively, the resources are not released but are made available to any newly executing software.

In one or more implementations, the device management module 260 combines the resources in two or more physical partitions to generate a single larger partition (corresponding to the physical function of one of the two or more physical partitions). For example, if two physical partitions have been established but are not currently executing software, and new software will be launched that requests resources greater than either of the two physical partitions has, the device management module 260 combines the resources of the two physical partitions into a single physical partition and coordinates with a resource map and management control module corresponding to the single physical partition.

In one or more implementations, the device management module 260 has full access to the resources of the computing device to configure and manage the physical partitions. However, the physical functions corresponding to the physical partitions have a lower privilege and are restricted to being able to access only the resources assigned to the corresponding physical partitions (e.g., as indicated by the resource map and management control modules). Furthermore, the physical functions are not able to alter the settings in the resource map and management control modules. Rather, the ability to alter the settings in the resource map and management control modules is reserved for the device management module 260.

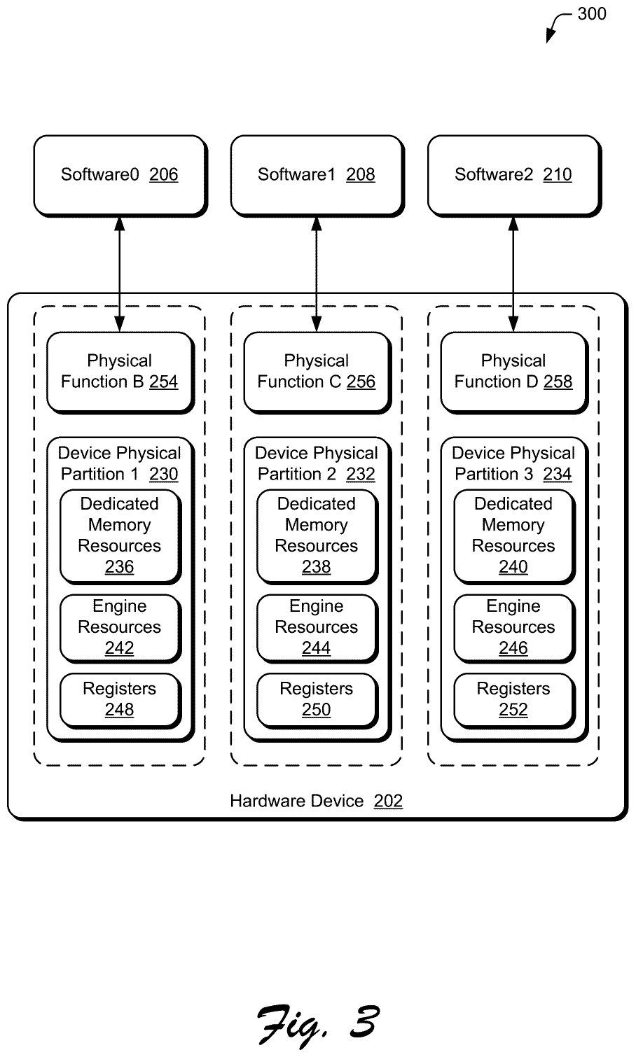

FIG. 3 is an illustration of the correspondence between software and physical partitions in accordance with one or more implementations. In the example 300 of FIG. 3, reference is made to the elements of FIG. 2. As illustrated, the hardware device 202 includes physical partition 230, physical partition 232, and physical partition 234, with corresponding physical function 254, physical function 256, and physical function 258, respectively. The example 300 also includes software 206, software 208, and software 210 (e.g., executing on the processor 102 of FIG. 1).

The software 206 is mapped to the physical function 254 and thus executes on the physical partition 230. The software 208 is mapped to the physical function 256 and thus executes on the physical partition 232. The software 210 is mapped to the physical function 258 and thus executes on the physical partition 234.

Furthermore, as discussed above, each software 206, 208, and 210 has its own corresponding kernel mode driver 224, 226, and 228, respectively, in the host 204. Accordingly, requests to perform operations from software 206, 208, or 210 are communicated to the physical function and physical partition corresponding to that software—other software is prevented from having operations performed on another physical partition. For example, software 208 and software 210 are prevented from having operations performed on physical partition 230.

Executing different pieces of software on different physical partitions enhances the security of the software. Each software is executed on a physical partition that has its own resources (e.g., memory resources, engine resources, registers), preventing software executing on one physical partition from accessing the resources of another partition.

Additionally, executing different pieces of software on different physical partitions improves the performance of the hardware device 202. The different physical partitions have different resources, so the pieces of software are executable on the different physical partitions concurrently. Time and resources need not be expended performing time sharing of the same resources.

It should be noted that although the example 300 illustrates three different pieces of software 206, 208, and 210 each corresponding to and executes on a different physical partition 230, 232, and 234, additionally or alternatively multiple pieces of software perform operations on the same physical partition. As an example, software 206 shares the physical partition 230 with an additional piece of software, so two pieces of software are mapped to the same physical function (e.g., physical function 254) and run on the same physical partition (e.g., physical partition 230).

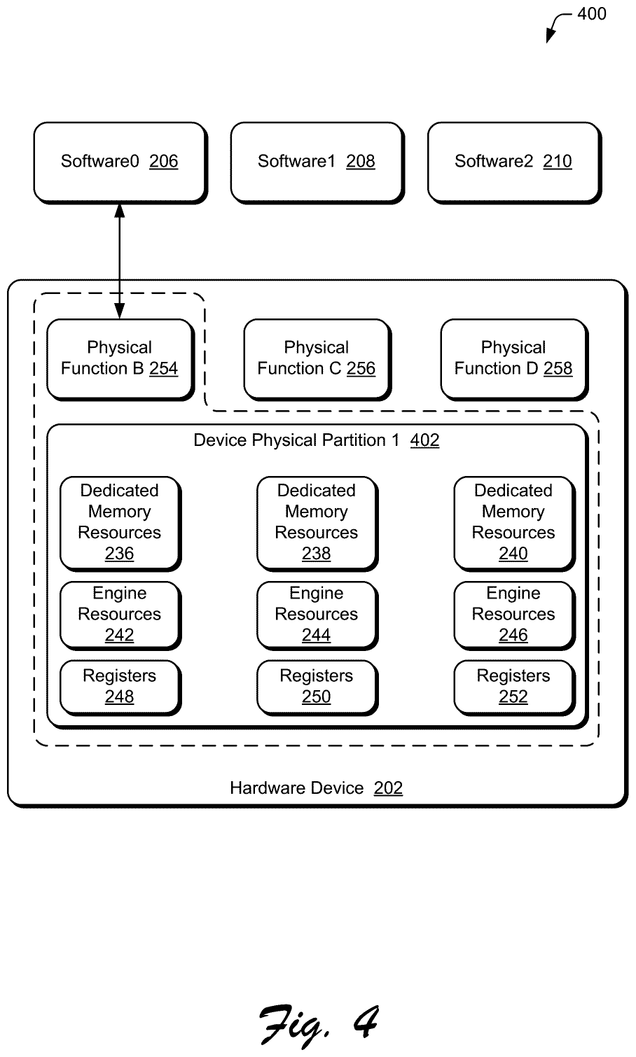

FIG. 4 is another illustration of the correspondence between software and physical partitions in accordance with one or more implementations. In the example 400 of FIG. 4, reference is made to the elements of FIG. 2. The example 400 is similar to the example 300 of FIG. 3, but differs in that a single software 206 has or owns all of the resources of the hardware device 202.

As illustrated, the hardware device 202 includes a single physical partition 402 with corresponding physical function 254. The example 400 also includes software 206, software 208, and software 210 (e.g., executing on the processor 102 of FIG. 1).

The software 206 is mapped to the physical function 254 and thus executes on the physical partition 402. The physical partition 402 includes the dedicated memory resources 236, 238, and 240, engine resources 242, 244, and 246, and registers 248, 250, and 252. Thus, the dedicated memory resources, engine resources, and registers that were split across three different device physical partitions in the example 300 of FIG. 3 are assigned to a single physical partition 402 in FIG. 4.

Furthermore, as discussed above, each software 206, 208, and 210 has its own corresponding kernel mode driver 224, 226, and 228, respectively, in the host 204. Accordingly, requests to perform operations from software 206, 208, or 210 are communicated to the physical function and physical partition corresponding to that software—other software is prevented from having operations performed on another physical partition. For example, software 208 and software 210 are prevented from having operations performed on physical partition 402.

The hardware device 202 includes physical function 256 and physical function 258, however no physical partition is associated with physical functions 256 and 258, and no resources are mapped to physical functions 256 and 258. Accordingly, software 208 and 210 cannot use the functionality of hardware device 202.

The techniques discussed herein operate in a bare metal environment, allowing pieces of software on a computing device to access the different physical partitions of the hardware device (via the mapped to physical functions) without having a hypervisor running on the computing device. However, the computing device is configurable and, for example after a reset or re-boot, allows the computing device to run in a different configuration that includes a hypervisor (e.g., a single root input/output virtualization (SR-IOV) mode). Accordingly, the techniques discussed herein do not prevent or interfere with operation of a hypervisor, or with a physical function being assigned to different guest virtual machines.

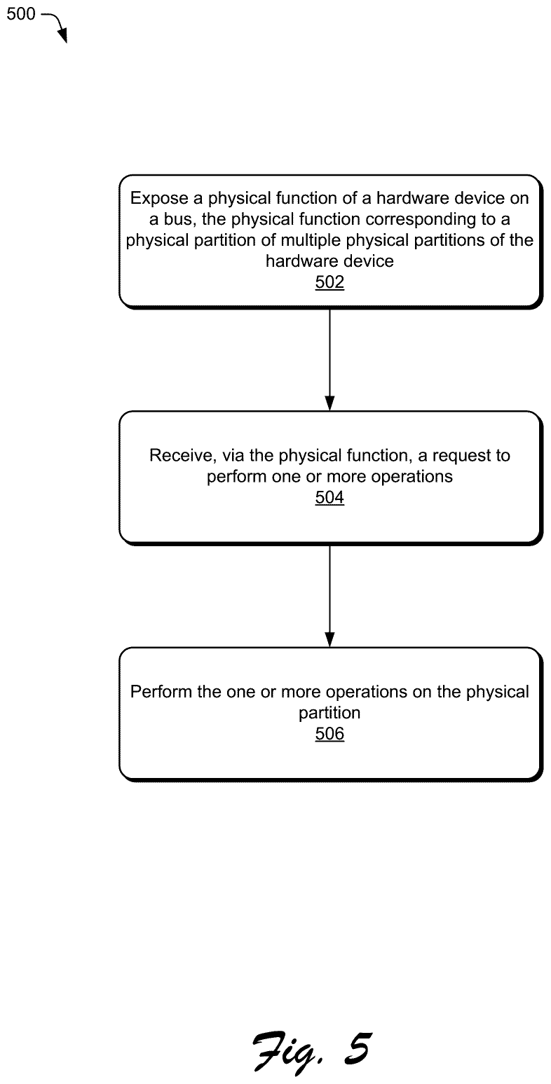

FIG. 5 is a flow diagram 500 depicting a procedure in an example implementation of accessing multiple physical partitions of a hardware device. The flow diagram 500 is performed by a hardware device, such as hardware device 104 of FIG. 1 or a hardware device 202 of FIG. 2, FIG. 3, or FIG. 4.

In this example, a physical function of a hardware device is exposed on a bus (block 502). The physical function corresponds to a physical partition of multiple physical partitions of the hardware device.

A request to perform one or more operations is received via the physical function (block 504). The one or more operations are received, for example, from software executing in a same computing device as the hardware device.

The one or more operations are performed on the physical partition (block 506).

The various functional units illustrated in the figures and/or described herein (including, where appropriate, the device management module 260, the resource map and management control 262, the resource map and management control 264, the resource map and management control 266) are implemented in any of a variety of different manners such as hardware circuitry, software executing or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a GPU, a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
exposing a physical function of a hardware device on a bus, the physical function corresponding to a physical partition of multiple physical partitions of the hardware device;
receiving, via the physical function, a request to perform one or more operations; and
performing the one or more operations on the physical partition.

2. The method of claim 1, wherein the bus comprises a peripheral component interconnect express bus.

3. The method of claim 1, further comprising:
exposing an additional physical function of the hardware device on the bus, the additional physical function corresponding to a device management module of the hardware device that manages the multiple physical partitions of the hardware device.

4. The method of claim 3, further comprising:
receiving configuration information corresponding to software, the configuration information indicating resources requested for execution of the software; and
configuring, based on the received configuration information, a physical partition including the indicated resources.

5. The method of claim 4, the software comprising a software container, an application, or a software stack.

6. The method of claim 1, further comprising:
exposing an additional physical function of the hardware device on the bus, the additional physical function corresponding to an additional physical partition of the multiple physical partitions;
receiving, via the additional physical function, a request to perform at least one operation; and
performing the at least one operation on the additional physical partition.

7. The method of claim 1, wherein the request is received from software via a kernel mode driver of a host rather than via a hypervisor.

8. A device comprising:
a physical function exposable on a bus coupled to the device to receive a request to perform one or more operations; and
a physical partition, corresponding to the physical function, to perform the one or more operations, wherein the physical partition is one of multiple physical partitions of the device.

9. The device of claim 8, wherein the bus comprises a peripheral component interconnect express bus.

10. The device of claim 8, further comprising:
an additional physical function exposable on the bus; and
a device management module, corresponding to the additional physical function, that manages the multiple physical partitions of the device.

11. The device of claim 10, wherein the device management module is to:
receive, via the bus and the additional physical function, configuration information corresponding to software, the configuration information indicating resources requested for execution of the software; and
configure, based on the received configuration information, the physical partition including the indicated resources.

12. The device of claim 11, wherein the configuration information is received from a management application that provides an interface to manage resources in the device.

13. The device of claim 8, further comprising:
an additional physical function exposable on the bus to receive a request to perform at least one operation; and
an additional physical partition, corresponding to the additional physical function, to perform the at least one operation, wherein the additional physical partition is one of the multiple physical partitions.

14. The device of claim 8, wherein the request is received from software via a kernel mode driver of a host rather than via a hypervisor.

15. A computing device comprising:
a bus; and
a hardware device coupled to the bus, the hardware device including a physical function exposed on the bus to receive, via the bus, a request to perform one or more operations, and the hardware device further including a physical partition, corresponding to the physical function, to perform the one or more operations, wherein the physical partition is one of multiple physical partitions of the hardware device.

16. The computing device of claim 15, wherein the bus comprises a peripheral component interconnect express bus.

17. The computing device of claim 15, further comprising:
an additional physical function exposed on the bus; and
a device management module, corresponding to the additional physical function, that manages the multiple physical partitions of the hardware device.

18. The computing device of claim 17, wherein the device management module is to:
receive, via the bus and the additional physical function, configuration information corresponding to software, the configuration information indicating resources requested for execution of the software; and
configure, based on the received configuration information, the physical partition including the indicated resources.

19. The computing device of claim 15, further comprising:
an additional physical function exposed on the bus to receive a request to perform at least one operation; and
an additional physical partition, corresponding to the additional physical function, to perform the at least one operation, wherein the additional physical partition is one of the multiple physical partitions.

20. The computing device of claim 15, wherein the request is received from software via a kernel mode driver of a host rather than via a hypervisor.
